(19) United States
(12) Patent Application Publication
(10) Pub. No.: US 2025/0078613 A1
(43) Pub. Date: Mar. 6, 2025

(54) GAMING TABLE HIGH-VALUE PROGRESSIVE SYSTEM WITH ANTICIPATION SIGNALS AND ENHANCED SECURITY

(71) Applicant: LNW Gaming, Inc., Las Vegas, NV (US)

(72) Inventors: Mark L. YOSELOFF, Henderson, NV (US); Russell Brooke DUNN, Henderson, NV (US)

(21) Appl. No.: 18/799,217

(22) Filed: Aug. 9, 2024

Related U.S. Application Data
(60) Provisional application No. 63/579,565, filed on Aug. 30, 2023.

(51) Int. Cl. G07F 17/32

(52) U.S. Cl. CPC G07F 17/3241; G07F 17/3244; G07F 17/3293

(57) ABSTRACT

An enhanced security progressive system for table games and a related method are disclosed. The disclosed system can include multiple gaming tables each with various components connected to a centralized progressive game controller/server. The system identifies and records progressive side wagers as they are placed and tracks cards as they are dealt to each player and to the dealer. The system issues alerts when potentially winning hands of sufficient magnitude are forming and indicates when such winning hands are actually achieved. Drawing the attention of players, the dealer, casino pit personnel, and/or automated table surveillance systems or surveillance personnel to winning hands as they are formed leads to both enhanced excitement for players and enhanced security for the casino. Such a system is particularly suited to the operation of high-stakes progressive games with primary progressive awards reaching levels of millions of dollars, non-limiting examples of which are also disclosed.

### CROSS-REFERENCE TO RELATED APPLICATION(S)

This patent application claims priority benefit of U.S. Provisional Patent Application No. 63/579,565 filed Aug. 30, 2023. The disclosure of the 63/579,565 Application is incorporated herein by reference in its entirety.

### COPYRIGHT

A portion of the disclosure of this patent document contains material which is subject to copyright protection. The copyright owner has no objection to the facsimile reproduction by anyone of the patent disclosure, as it appears in the Patent and Trademark Office patent files or records, but otherwise reserves all copyright rights whatsoever. Copyright 2023-2024, LNW Gaming, Inc.

### FIELD OF THE INVENTION

The present invention relates to the field of table gaming, wagering methods and apparatus on gaming tables, and leveraging the automated recognition of cards on gaming tables.

### BACKGROUND OF THE INVENTION

In casino table games, wagering was originally done (and in many circumstances is still done) exclusively by the physical placement of money, currency, coins, tokens or chips on the gaming table and allowing the wager to remain on the gaming table until conclusion of the game and resolution of the wager(s). The placement of physical wagers on tables allows for some players to attempt to commit fraud on casinos by late placement of wagers, alteration of wagers and particularly placement of side bet wagers, bonus wagers and jackpot wagers. Furthermore, some players may commit fraud by introducing cards into play that were not dealt by the dealer.

Side bets, bonus and jackpot payouts can reach levels of hundreds of thousands or even millions of dollars at gaming tables and the temptation to commit fraud at a table increases. Similarly, the casino's need to prevent fraud increases to assure the game is fair to players. With the linkage of games (e.g., different games) within a casino or among different casinos, a uniform standard of control is needed that assures equal avoidance and prevention of cheating at all tables and at all facilities.

In the past twenty years, numerous systems have been provided or disclosed for the automated recognition of wagers, including side bet, bonus and jackpot wagers. Among the disclosures of these types of technologies include U.S. Pat. No. 5,794,964 (Jones) in which a sensor detects when a gaming token is dropped into a slot on the gaming table and a coin acceptor is mounted to detect the passage of a gaming token through the slot.

U.S. Pat. Nos. 5,544,892, 6,299,534 and 7,367,884 (Breeding) disclose an apparatus for detecting the presence of a gaming token. This apparatus has at least one predetermined location for receiving a gaming token on a gaming table. At each predetermined location for receiving a gaming token designated on the gaming table, a proximity sensor is mounted to the gaming table such that each sensor is aligned with one predetermined location. A decoder is electrically connected to each proximity sensor for determining whether a gaming token is present at each predetermined location. When the presence of a gaming token is sensed by the decoder, the player's bet is registered by transmission of the sensed presence to a processor. Each sensor in these systems has a connection to a processor (e.g., game processor or system processor) where the individual wagers are recorded and identified. In a preferred embodiment, there is a backlight under the predetermined location that lights up when a wager is made at that location that remains lit when the processor identifies acceptance and recognition of the wager during each game or round of play at the gaming table. These systems are used for the management and operation of progressive awards.

Various systems for recognizing playing cards, wagers and the like dealt in the round of a game at a gaming table are also known. For example, U.S. Pat. No. 11,205,319 (Kelly) discloses a system and method for training a neural network associated with a casino table game monitoring system. Synthetic images of objects extracted from a virtual table game environment are used to create a ground truth set, which is then used to train and test a neural network. When the neural network's classification of the extracted images is deemed accurate enough, the neural network may then be deployed in a casino to track the use of corresponding physical objects in real casino table game play as part of the casino table game monitoring system.

Further, card dispensing devices such as automated card shufflers and/or shoes have been used to track cards dealt in a round of play at a gaming table. Examples may be found in U.S. Pat. Nos. RE46826 (Hill), U.S. Pat. No. 7,661,676 (Smith), U.S. Pat. No. 9,452,349. U.S. Pat. No. 7,137,627 (Grauser) discloses an automated shuffler for continuously shuffling playing cards, whereby the dealer has a substantially continuously readily available supply of shuffled cards for dealing and where cards may be monitored for security purposes during play of the game.

A plurality of gaming tables may be connected together in the system to link progressive proprietary table games that include a progressive award component, such a variety of blackjack, pai gow poker and baccarat games. Other examples of progressive games may include the CARIBBEAN STUD® poker game, the THREE CARD POKER PROGRESSIVE® poker game, the PROGRESSIVE TEXAS HOLD'EM™ poker game, etc. Examples of systems which link multiple table games are disclosed in U.S. Pat. Nos. 5,393,067 and 4,861,041.

### SUMMARY OF THE INVENTION

In accordance with one or more embodiments, an enhanced security progressive system for table games and related methods are disclosed. The disclosed system can include multiple gaming tables each with a dealer terminal and various other components connected to a centralized progressive game controller/server. The system identifies and records progressive side wagers as they are placed and tracks cards as they are dealt to each player and to the dealer. The system issues alerts when potentially winning hands of sufficient magnitude are forming and indicates when such winning hands are actually achieved. Drawing the attention of players, the dealer, casino pit personnel, and, in some embodiments, automated table surveillance systems or surveillance personnel to winning hands as they are formed leads to both enhanced excitement for players and enhanced security for the casino. Such a system is particularly suited to the operation of high-stakes progressive games with primary progressive awards reaching levels of millions of dollars, non-limiting examples of which are disclosed herein.

Additional aspects of the invention will be apparent to those of ordinary skill in the art in view of the detailed description of various embodiments, which is made with reference to the drawings, a brief description of which is provided below.

### BRIEF DESCRIPTION OF THE DRAWINGS

FIG. 1 is a top plan view of an exemplary gaming table apparatus with an integrated wager sensing system including a plurality of token bet sensors.

FIG. 2 is a block diagram of a gaming table illustrating the connections between major components in accordance with one or more embodiments.

FIG. 3 is a pay table of an exemplar blackjack game in accordance with one or more embodiments.

FIG. 4 is an example of a gaming table layout associated with the game of FIG. 3.

FIGS. 5A and 5B are a process flow chart for an exemplary use case using the components of FIG. 1 and FIG. 2 and the game of FIG. 3 in accordance with one or more embodiments.

FIG. 6 is a pay table of an exemplar baccarat game in accordance with one or more embodiments.

FIG. 7 is an example of a gaming table layout associated with the game of FIG. 6.

### DETAILED DESCRIPTION

While this invention is susceptible of embodiment in many different forms, there is shown in the drawings and herein described in detail preferred embodiments of the invention with the understanding that the present disclosure is to be considered as an exemplification of the principles of the invention and is not intended to limit the broad aspect of the invention to the embodiments illustrated. For purposes of the present detailed description, the singular includes the plural and vice versa (unless specifically disclaimed); the words “and” and “or” shall be both conjunctive and disjunctive; the word “all” means “any and all”; the word “any” means “any and all”; and the word “including” means “including without limitation.”

In accordance with one or more embodiments, the present enhanced security progressive system for table games identifies and records progressive side wagers as they are placed. Typically, a side wager token sensor is placed at each player position. If a side wager is placed on the sensor, this information is forwarded to a table controller that, in turn, passes the information to a central progressive/game server. Once recorded, the side wagers may be removed by the table dealer to keep them out of the way during game play and to avoid having them surreptitiously pulled back by a player once the player has seen one or more cards and realizes no side bet will be won. A card handling device such as an automated shuffler or card-tracking shoe tracks cards as they are dealt to each player and to the dealer. The value of each dealt card may be sent to the table controller and to the central progressive/game server. The system correlates dealt cards with player positions and previously recorded side wagers data and references a pay table to identify potential and actual winning hands in near real time as cards are dealt. The system may issue anticipation alerts, as appropriate, on the dealer terminal, on a publicly visible table sign and/or on lights or displays on or at the token sensors when potentially winning hands of sufficient magnitude are forming. As more cards are dealt, the system further indicates when such winning hands are actually achieved. As noted above, drawing the attention of the players, the dealer, casino pit personnel, and, in some embodiments, automated table surveillance systems to the formation of potentially winning hands leads to both enhanced excitement for players and enhanced security for the casino. Such systems are particularly suited to the operation of high-stakes progressive games with primary progressive awards reaching levels of millions of dollars, though also useful for games with lower stakes.

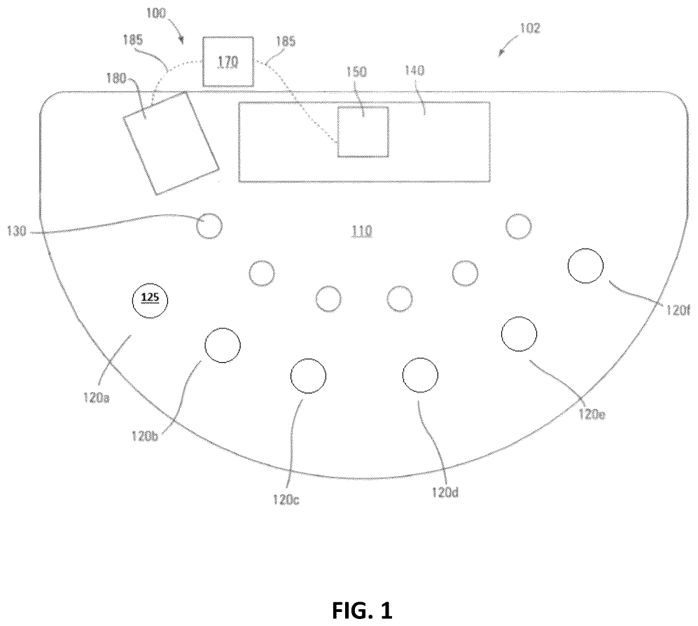

Reference to the figures will further assist in an appreciation of the present invention. FIG. 1 is an exemplary gaming table 102 with a game management system 100. The game management system 100 may be used for a progressive jackpot system such as the system disclosed in U.S. Pat. No. 5,794,964 (Jones) or in any other bonus or side bet feature system. According to the invention, the gaming table 102 has a gaming table layout 110, preferably a felt surface with indicia thereon identifying elements of the game, such as wager positions and odds. A chip tray 140 is disposed opposite a plurality of player positions 120 (120a-120f). Preferably, chip tray 140 includes an integrated dealer input and display 150 which is part of the dealer terminal. The system further includes game controller 170 electrically connected to the integrated dealer input and display 150 by system wiring 185. Preferably, the system also includes card handling device 180, such as a shoe or a shuffler, which is also electrically connected to game controller 170 by system wiring 185. It is further preferred that the card handling device 180 contain card reading functionality so that cards stored, delivered or withheld have at least one of suit and rank read and that information processed as desired, as disclosed for example in U.S. Pat. Nos. 7,769,232; 7,766,332; 7,764,836; 7,717,427; 7,677,565; 7,593,544; and 7,407,438. In the preferred embodiment, the card handling device is a continuous shuffler whereby the dealer has a substantially continuous readily available supply of shuffled cards for dealing. Preferably all cards are available at the beginning of a round of play and where cards may be monitored for security purposes during play of the game. U.S. Pat. No. 6,265,096 discloses such a shuffler. An example of a suitable commercially available continuous shuffler is a ShuffleStar™ shuffler available from Light & Wonder, Inc.

Each player position 120 includes wagers areas 125 and a side wager area, which comprises a token sensor assembly 130. The preferred embodiment will allow one token sensor assembly for each player position 120, which player positions will number six or seven on a standard gaming table for games like blackjack, baccarat, pai go poker, TEXAS HOLD 'EM BONUS® poker, THREE CARD POKER® and the like. Systems with parallel connections between token sensors 130 and processors are preferred over serial daisy-chained connections because failure of a single token sensor 130 will not prevent use of the remaining token sensors 130 in operation, however any connection scheme may be used. While, in this example, each token sensor 130 is used for sensing only a side game or progressive wager, it is understood that token sensors could be used for any and all wager areas without deviating from the scope of the invention. Information acquired from the token sensors is transmitted to an external progressive system or game manager, a suitable example of which is the GM Atlas system commercially available from Light & Wonder, Inc. The progressive system uses the collected side wager information to manage one or more progressive pools, for example, by incrementing a meter associated with each pool. The progressive system also resets each meter to a reset value when a particular progressive award is won.

The game controller 170 provides instructions to the token sensors 130, such as signaling a new round of game play, whether to light up indicators such as colored light emitting diodes (LEDs) incorporated into the token sensors 130 or text or graphics to present on a display integrated into or adjacent to each token sensor. Upon receiving these instructions, the token sensor 130 presents any display information and/or determines a presence of any particular wager, especially a progressive wager, a side bet wager, optional or mandatory bonus wager and the like according to the rules of and the state of the game being played.

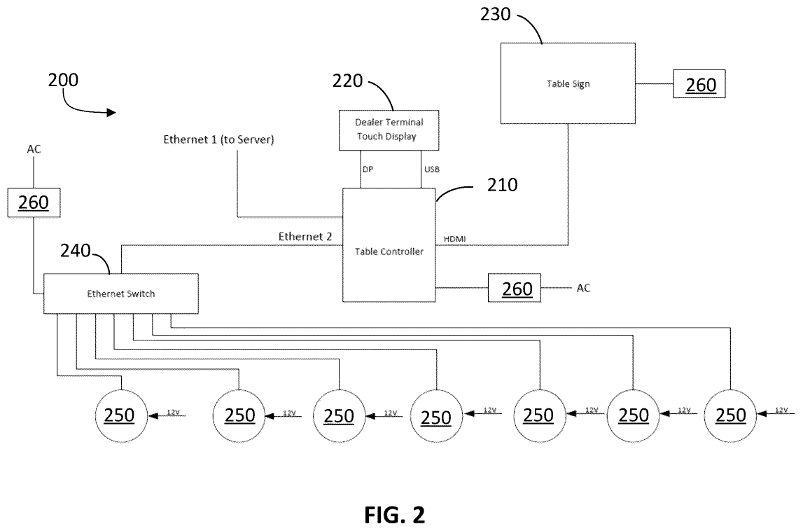

FIG. 2, in accordance with one or more embodiments, provides a block diagram of connections between various components for a gaming table 200 similar to the gaming table 102 described above with reference to FIG. 1. Table controller 210, which may be, for example, a Nexus Command II Table Controller manufactured and sold by Light & Wonder, Inc., is connected via USB and DisplayPort connections to a dealer terminal 220, which for example, may include an LCD display panel with a touchscreen input, one or more separate buttons, etc.

The table controller 210 is also connected to a table sign 230 via an HDMI cable. The table sign 230 is typically a video display monitor used to graphically display game title, wagering limits, progressive award information, side game displays, animations and the like. The HDMI cable to the table sign 230 may also include audio content playable through audio components, such as an amplifier and speakers, of the table sign 230. The table sign 230 may include minimum and maximum bets allowed at the gaming table, winning hand animations and trends, data related to previous rounds played, for example, trends based on previous outcomes, and a historically based prediction table for games such as baccarat. The display may be rotatable from a portrait to a landscape orientation, depending on the game being played at the gaming table. In some cases, the table sign 230 may include multiple displays so the content displayed on the table sign 230 is simultaneously viewable from multiple directions. A bezel surrounding each display may include one or more “emotive lighting” strips typically populated with programmable color light-emitting diodes (LEDs) suitable for displaying information such as a color-coded minimum bet or anticipation signals advertising the likelihood of an upcoming high-paying outcome. These features help draw players to the gaming table and enhance the excitement of the players already present at the gaming table. Examples of commercially available table signs 230 include the i-Score™ Plus and i-Score™ Ultra table signs from Light & Wonder, Inc.

The table controller 210 is also connected via a first ethernet connection to a remote central game/progressive server, for example, the GM Atlas system mentioned above. A second ethernet connection communicatively couples the table controller 210 to an ethernet switch 240. The ethernet switch 240 serves as a centralized connection point for token sensors 250 and provides a communication link between the table controller 210 and the token sensors 250. The table controller 210, the dealer terminal 220, the table sign 230 and the ethernet switch 240 are typically powered by alternating current power supply units 260. The token sensors are typically powered by 12 vdc supplied by a direct current power distribution hub (not shown) also connected to a power supply unit 260.

While certain functionality may be described as assigned to a particular device in the system, for example, card tracking to the card distribution device, side bet token sensing to the game/progressive server via the table controller 210, and so on, any system configuration and distribution of processing amongst the various processors within the system that provides the functionality ascribed to logic-circuitry herein falls within the spirit and scope of the invention.

One of the most popular card games, the general rules of blackjack (“Twenty-One” or “21”), are well known. However, a summary of the rules is provided here.

The basic game of blackjack is played with one or more standard decks of cards wherein each rank of card is associated with a numerical value (e.g., royalty is worth 10 points). The object of the game for the players is to be dealt or otherwise develop a hand of cards having a cumulative value closer to 21 than the dealer's hand, provided that no hands exceed 21.

Players are each initially dealt hands consisting of two cards which are displayed face up to compete against the dealer's band of two cards, with one card of the two cards being displayed face up while the other card is hidden (e.g., face down). The rules of the basic game then provide a round in which each player has the opportunity to maintain the initial hand as dealt (referred to as “sticking” or “standing”) or receive additional cards (referred to as “hitting”) Cards can be added to the hand until the cumulative value of the hand exceeds 21. A player with a cumulative hand value greater than 21 loses the game (referred to as “busting”) and any wager is relinquished.

Once this round has been completed, the dealer reveals the hidden or “hole” card to the players and either stands or hits. In this basic version of the game of blackjack, the dealer does not have the ability to decide whether to stand or hit. Rather, the decision is dictated by the house rules. For example, house rules may dictate that the dealer must typically take another card if the cumulative hand value equals 16 or less and must stand on any hand having a value of 17. In other variants of the game of blackjack, the dealer must take a hit on a “soft” 17, that is, a 17 that was made with an Ace counted as 11. Accordingly, if the dealer's hand eventually exceeds 21, the dealer loses the game and the remaining players win and are paid based on their wagers. In the event that both the player and dealer have the same value hands, this is known as a “push” and the player retains the wager.

The house or casino has the advantage because the blackjack player must play and complete their hand before the dealer plays or completes his hand. However, blackjack is relatively simple to understand and is a fast and easy card game for most players to play. Additionally, many players exercise some form of strategy when playing the game which improves their odds of winning. These strategies are often based on assessing a combination of factors such as the player's initial hand value, an estimation of the dealer's hand based on the one visible card and mathematical probability that the hidden card will be of a particular value, along with the chances that taking any additional cards will cause the player or dealer to eventually bust.

While the basic game of blackjack is a relatively fast-paced card game, it is always desirable to offer the players opportunities for variations in the game to maintain their long-term interest. Thus, other betting options are desirable for the blackjack player other than just varying the size of their wagers. These additional betting options typically also increase the revenue earned by each table. Thus, attempts have been made to vary the basic game of blackjack to provide players with additional wagering options as compared to the wagering options in the basic game. There are numerous variations of blackjack that include side bets on various events comprising specific events resulting from player cards only and combinations of player cards and the dealer's up card. Such games include, but are not limited to Lucky Ladies™ game, Ultimate Blackjack, and Lucky Jacks and Queens. As an example, “Lucky Ladies™” is a blackjack variant that involves a side wager that is made by the player in a blackjack game against the occurrence of pairs in the player's hand. There is a particularly large bonus for the occurrence of a pair of a specific rank and suit (e.g., two Queens of Hearts) in the first two cards when the dealer bas a blackjack.

Similarly, in accordance with one or more embodiments, the presently disclosed “Diamond Millions Blackjack Progressive” is a progressive side wager for blackjack. An optional or mandatory side wager (at the operator's discretion) for the standard game of blackjack allows the chance for the player(s) to receive a variable payout for specific blackjack hands (Ace & Ten, King, Queen, Jack). The payout is determined by the posted pay table applied to the first two cards received by the player and the initial two cards dealt to the dealer.

A “Diamond Millions Blackjack” consists of a Queen and Ace of Diamonds. The primary progressive award is won when both the player and dealer are dealt a “Diamond Millions Blackjack.” (These specific cards are but an example. Any two designated cards, when dealt as the first two cards to a player and also to the dealer, fall within the spirit and scope of the invention.)

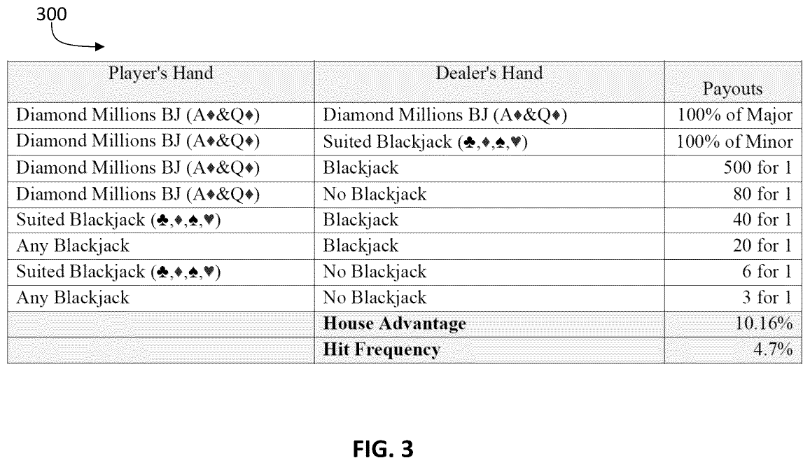

FIG. 3, in accordance with one or more embodiments, provides an example of a Diamond Millions Blackjack pay table 300. As shown, in addition to a primary progressive award, the side game offers lesser paying amounts for a variety of other winning combinations with a frequent enough hit frequency to encourage a casual player to place a side wager. Only players who place a side wager for this special pay table in a given round are eligible for the awards described by the pay table during that round. Thus, a player may opt to participate in the side game, or not, on a per round basis. As shown, the pay table may include “envy” bonuses. An envy bonus is paid to every other player at the table who participated in the side game when one of the participating players at the table wins the primary progressive award.

Diamond Millions Blackjack, as shown, is played with six decks of standard playing cards. It is preferred that the game be dealt from a continuous shuffler machine to ensure that the cards required for a player to receive the winning combination(s) are available each and every round and to provide an added layer of security with the device's built-in “cards out verification” feature and the option to pass the identity of dealt cards to the system in near real time.

To begin each round, players will be required to place a standard blackjack wager and the Diamond Millions Progressive wager. The player may not make the Diamond Millions wager without a standard blackjack wager. The amount wagered on the Diamond Millions spot must be the fixed amount (e.g., $1, $5, $25) posted on the table and are subject to all payout limitations posted by the casino. The Diamond Millions payouts may also be subject to a table aggregate payout limit set by the casino.

Player(s) win if they are dealt a Blackjack. Odds increase with a player(s) suited blackjack and/or with a dealer blackjack. The top pay is awarded with a player Diamond Millions Blackjack (Ace & Queen of Diamonds) and a matching dealer Diamond Millions Blackjack.

The likelihood of both a player and the dealer both having a Queen and an Ace of Diamonds in their first two cards is extremely low, in contrast to the afore-mentioned Lucky Ladies™ game, for example, where it is much easier for the player to have two Queens of Hearts and for the dealer to have a wide variety of non-specific blackjacks. When it takes longer, on average, for a winning progressive outcome to occur, naturally, the size of the progressive jackpot increases, on average, to a much larger value. For example, at a $5 bet, the average Diamond Millions Blackjack progressive value may reach over $5 million, with an envy bonus of about $90,000, to be divided amongst the other participating players at the table. The average number of hands between primary progressive wins is 2,581,860. With an average of 200 participating tables and an average of 500 dealt rounds per day, the progressive should occur, approximately, every 26 days.

A secondary progressive is won when the player has a Diamond Millions Blackjack, and the dealer has any other suited blackjack. The secondary progressive should average just over $100,000 when hit and should hit, on average, every 123,652 hands. Again, with 200 tables and 500 hands per day, the secondary progressive should occur, on average, every 1.24 days. This relatively high frequency encourages players to play the game for a prize amount which, while not millions of dollars, is still a significantly large amount.

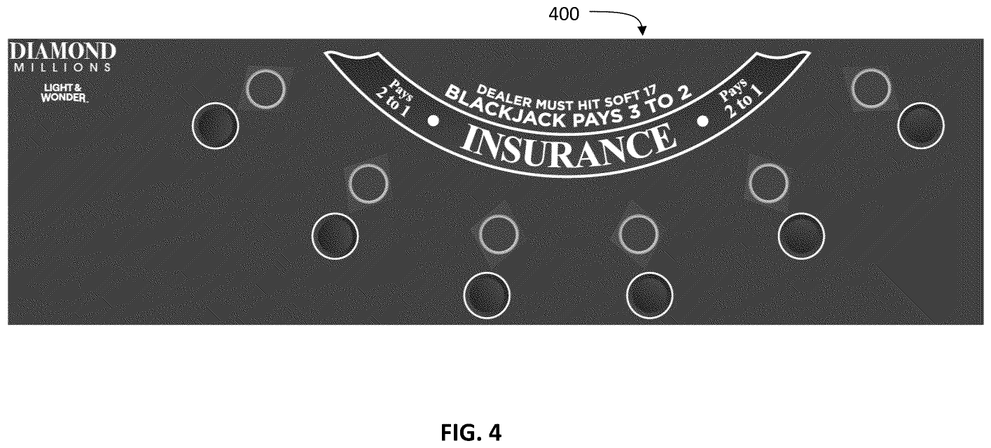

The house advantage in the example of FIG. 3 is at least 10%. The hit frequency of any win in the side game pay table is 4.7%. The pays in the fixed portions of the pay table may be altered to adjust the house advantage and hit frequency, with the understanding that a balance must be struck between the two so that enough players opt to place the side wager to play the game. FIG. 4 illustrates an example of a gaming table layout 400 (akin to gaming table layout 110 of FIG. 1) that may be used with the exemplar Diamonds Millions Blackjack side game.

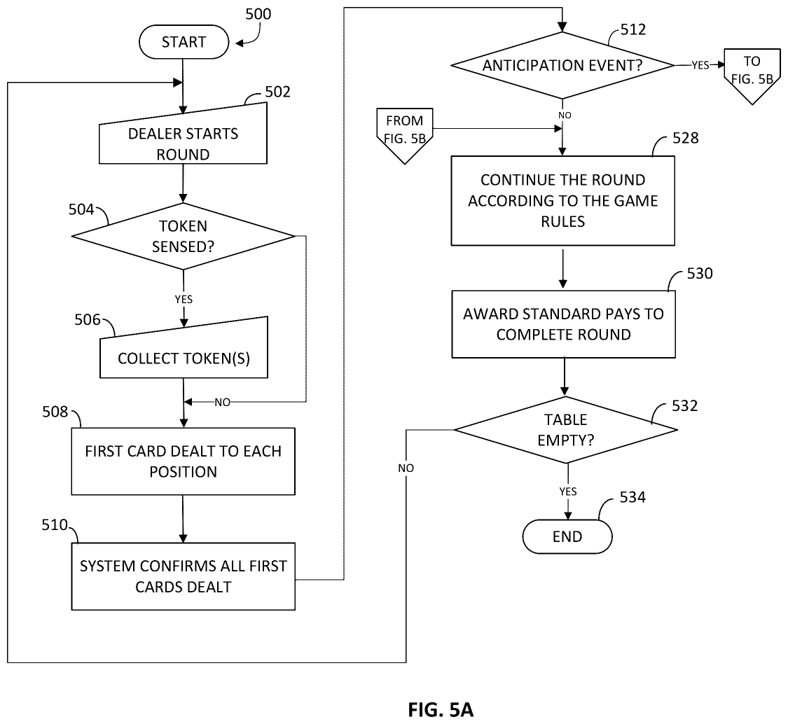

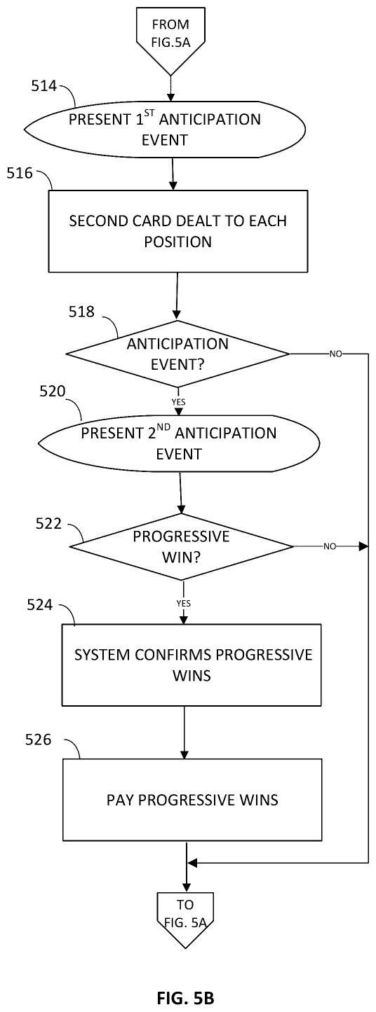

Referring now to FIGS. 5A-5B, there is shown a flow diagram representing one data processing method 500 corresponding to at least some instructions stored and executed by the table controller 210 of FIG. 2 to perform operations of an exemplar use case of the present invention including a game similar to the game of FIG. 3. Thus, the data processing method 500 relates to a table game including a side game enabled by a side wager that pays at least one progressive award. Various elements of FIG. 1 and FIG. 2 will be referenced in the description of FIGS. 5A-5B.

At step 502, the dealer starts a game round. The dealer may enter a command on the dealer terminal touch display 220 to indicate to the table controller 210 that the game round has begun. In accordance with some embodiments, the dealer's command may include the number of wagering players in the game round, for example, seven players. This value provides an important piece of security information to the system and, if not explicitly entered, must be determined by the system. Various alternate methods for this system-based determination are described below.

In response to the initiation of the game round, the table controller 210 may announce the start of the game round on the table sign 230. For example, the table sign 230 may display instructions for placing a side game wager: “Place a $5 side wager token here for a chance to win $5,230,286.50!” Optionally, a countdown timer indicating how long the side game wagering period will be in effect may be displayed. The token sensors 250 may also be commanded to flash their LEDs in a particular color, for example, green. As each token sensor 250 detects a token on its surface, this information is sent to the table controller 210, which may then command the token sensor 250 to change the state or color of its LEDs to acknowledge the presence of the token, for example, from off to on or from green to white. At the conclusion of the wagering period, the table controller may display “No More Bets” on the table sign 230 and change the color of the LEDs on the token sensors 250 of non-participating positions off or from green to, for example, red.

In accordance with some embodiments, the table sign 230 may provide players with side game anticipation information. When a continuous shuffling device is not used, the number of “good cards” dealt in previous rounds prior to a new shuffle may indicate an increased probability of a progressive win occurring. For example, if three rounds of play have already been dealt from a shoe and only one Queen of Diamonds and one Ace of Diamonds have been dealt in those previous rounds, the probability of several Queens of Diamonds and Aces of Diamonds being dealt in the current round are higher than normal. This may be indicated on the table sign 230 through a change in color, either on the display(s) or in one or more “emotive lighting” bands surrounding the bezel of the display, from “hot” to “cold,” by way of a “thermometer,” etc. Other approaches may be used. For example, if a particular side bet is expected to win at least once per shoe and half of a shoe has been dealt without that particular win occurring, the table sign 230 may be used to indicate this anticipation situation. In accordance with some embodiments, colored LEDs of the token sensors 250 may also gradually change from a “cool” color such as blue to a warm color such as orange or a hot color such as red, depending on the relative likelihood of a progressive win or more side game pay table wins occurring. This can encourage a player who might not otherwise place the side wager to take a chance on winning a prize in the side game. It should be understood that the above examples may be specific to the blackjack game being described, however, any analysis of cards already dealt in previous rounds of any game that triggers an anticipation display falls within the spirit and scope of the invention.

At step 504, if no side game wagers were placed, the flow continues to step 508. Otherwise, one or more tokens have been sensed on the token sensors 250 and, at step 506, the tokens are collected from the token sensors 250 by the dealer and placed into the chip tray 140 (FIG. 1). The table controller 210 monitors the token sensors 250 for removal of the tokens and “locks in” the side game wager for each respective table position as its token is removed. The table controller 210 may turn the token sensor LEDs at “locked-in” table positions to a specific color, such as green, and those without a side game wager to another color or to off. The table controller 210 notifies the progressive server of each locked-in side game wager for the purposes of incrementing the progressive award.

At step 508, the dealer deals the first card of the game round, for example, by removing and distributing cards from the card handling device 180 (FIG. 1) to each player position 120 (FIG. 1) and to the dealer position.

At step 510, the system determines that the first card of the round has been dealt to all players and to the dealer. As an example, for the purposes of anticipation alerts, discriminating between a “good” player card and a “good” dealer card is an important aspect of the system that may be handled in several ways. In blackjack, for example, some of the dealer cards are hidden until later in the game, thus, only “good” player cards are typically used to initiate anticipation signals (FIG. 5B, step 514). In contrast, anticipation alerts may be issued for all baccarat cards. Thus, for Baccarat, as described in detail below, the system may make anticipation decisions based on whether a card is a player card, a dealer card, what the game rules are, etc. Thus, at step 510. the table controller 210 determines if the first card of the round has been dealt to all positions, including the dealer. This is important because it is possible for the system to determine how many players are playing once a dealt card is known to belong to the dealer. The number of players in blackjack, for example, is equal to the number of first cards dealt minus one card, which goes to the dealer. Thus, if the system knows, from the card handling device 180, that six cards have been dealt and that the dealer has received a first card, the number of blackjack players is five. The identification of each card dealt, obtained from the card handling device 180, may then be assigned to its respective player. Thus, the system makes anticipation decisions based on whether a card is a player card, a dealer card, what the game rules are, etc., and knowing when the first card has been received by all players and the dealer is important.

In accordance with one or more embodiments, the dealer may simply press a button on the dealer terminal 220 to signal that the first round of cards has been completely dealt. In other embodiments, a camera in the table sign 230 aimed at the dealer position may include software capable of recognizing the presence of a card at the dealer position and signaling that presence to the table controller 210.

In these embodiments, no attempt is made to detect which betting locations have an active wager. However, there are ways for the system to also detect and use this information, not only for anticipation purposes but for win confirmation (FIG. 5B, step 524). These additional security aspects are important when, as here, progressive awards are exceedingly high.

In accordance with one or more embodiments, an additional token sensor may be placed at the ante betting position of each player position 120 (FIG. 1). It is then possible to identify active betting positions (active seats) and, because cards are dealt in sequence, to assign the identification of player cards to those positions. Furthermore, input from the side wager token sensors 250 allows the system to know when a side wager has been placed at a particular player position 120. When these inputs are combined, the system can determine whether a progressive has been won (described below at step 524) and at what player position 120. This information can be reported to casino personnel responsible for paying the winning players and resetting the system. Because the system is reporting its win information based on card data from the card handling device, it confirms that neither the winning player (or a colluding dealer) introduced any unintended “good” cards onto the table. Displayed on the table sign 230, the win confirmation information also provides winning players with a sense of security because confirmation of the win by the system is less likely to be disputed by the casino. When jackpots rise to the level of millions of dollars, such enhanced security is important and may, in some cases, be required by jurisdictional regulations.

According to one other aspect of the present disclosure, rather than installing a base bet token sensor to associate player hands to player seat positions, a vision system is provided for determining, via image analysis (e.g., via a computer-vision model), where base bets have been made. The vision system may also be capable of determining an outcome value (e.g., a card value) of a randomizing game object (e.g., a playing card) for the game played at a gaming table and also detecting, based on the outcome value and one or more game rules, an occurrence of a winning outcome for the game. For example, one or more cameras may have a lens pointed at the gaming table in a way that views portions of the surface of the gaming table relevant to game play and that views game participants (e.g., players and dealer) positioned around the gaming table. The vision system can further determine, via image analysis, a location at a gaming table surface related to each betting location 120 (FIG. 1). The vision system may also include a tracking controller communicatively coupled to the camera to receive the captured image data. The tracking controller detects and identifies a physical object depicted in one or more frames of the captured image data. For instance, the tracking controller applies an image neural network model to the captured image data to determine the shape of the object and to determine its location relative to a field of view of the camera. The tracking controller may further perform image segmentation on the captured image data. The tracking controller further maps the shape of the object to a virtual mask. For instance, the tracking controller generates a mask at pixel locations in a virtual scene that correspond to pixel locations of a boundary of the object identified in the captured image. The tracking controller further determines the game state of the wagering game and determines, based on the game state, relevance of the object to the game state. To analyze the images, the gaming system may utilize one or more neural network models. Examples of such systems may be found in U.S. patent application Ser. No. 17/217,172 published as U.S. Pub. No. 20210304550, which is incorporated herein by reference in its entirety. Applied to the embodiments of the present invention, the tracking controller may both be used to determine at which betting location 120 a base wager has been made and when the first card has been dealt to the dealer (step 510). Thus, both anticipation (steps 512 and 514) and security aspects (step 524) are supported.

Regardless of how the completion of dealing of the first card is detected by the system, at step 512, the system may, at that time, determine whether the dealt cards contain “good” cards that represent a potentially winning hand for the primary progressive. If not, no progressive can be won and flow continues to step 528.

However, if the round of first cards contains one or more “good” cards, flow continues to step 514 on FIG. 5B. On the first card, the alerts will typically be first-level anticipation alerts. For example, if a player is dealt an Ace of Diamonds or a Queen of Diamonds, the table sign 230 may generate a chime, “ding,” or other brief sound to signal that a “good card” has been dealt. This may apply to all players, whether actually participating in the side game or not, or only to players participating in the side game. Alternately or in addition, LED or lights on the token sensors may flash briefly as an anticipation alert. Though the dealer card is known to the system, in blackjack, it is face down and will typically not be used for anticipation alert purposes. However, if at least one “good” player card has been dealt and the dealer's first card is also a “good” card, the system may alert automated surveillance systems to focus on the table. For example, a steerable surveillance camera may be aimed at the table or the view of a fixed camera zoomed in.

At step 516, the second card of the round is dealt to each position.

At step 518, after the identification of each second card has been sent to the system by the card handling device, the system may determine whether the two dealt cards at a given seat position contain two “good” cards that continue to represent a potentially winning hand for the primary progressive, for example, if at least one player has been dealt both an Ace of Diamonds and a Queen of Diamonds. If not, no progressive can be won and flow continues to step 528 of FIG. 5A.

Otherwise, at step 520, the table sign 230 may generate a louder or longer chime, “ding,” or other sound to signal that a “very good hand” has been dealt. Alternately or in addition, lights on the token sensors may flash briefly or otherwise signal a second level anticipation alert. An appropriate message may be displayed on the table sign 230. If not already alerted at step 514, surveillance cameras and/or personnel may be alerted.

At step 522, the system takes the dealer cards into consideration and determines whether a progressive win has occurred. For example, if the game is blackjack and at least one player has an Ace of Diamonds and a Queen of Diamonds and the dealer cards are also an Ace of Diamonds and a Queen of Diamonds, the primary progressive has been won.

If there is no progressive win detected at step 522, flow proceeds to step 528 of FIG. 5A. However, if there is a progressive win at step 522, flow continues at step 524, where the system displays confirmation of the win on one or more of the dealer terminal 220, the table sign 230, displays integrated into the token sensors 250, through audio speakers, etc. The system then locks up the game until the appropriate awards are verified and paid by casino personnel at step 526. The dealer may assist the system in confirming winning progressive hands by, for example, pressing a jackpot button on the dealer terminal 220 and entering the qualifying hand. If not already alerted by the system, the dealer typically then contacts a supervisor. Once the casino verifies the progressive win, the supervisor will press a confirm button. To complete the action, a supervisor or higher executive card (depending on the jackpot size) swipe or other authentication may be required. This records the win with the progressive/game manager and adjusts the progressive meter(s) appropriately for the prize(s) won. House procedures are then followed for paying the prize.

Once the progressive side game awards have been paid, the game is unlocked via one or more commands on the dealer terminal 220 and flow returns to step 528 of FIG. 5A to complete the remainder of the game round according to the standard game rules, starting with paying any winning side game hands other than progressive hands from the dealer's chip tray 140. The dealer then completes dealing the remainder of the game round that is not part of the side game. For example, in blackjack, each player may, in turn, stand or hit according to the normal game rules, the dealer may or may not draw cards according to the normal game rules and then any losses are collected and winning hands are paid at step 530.

At step 532, if at least one player remains at the table, the flow continues to step 502, where the dealer starts another game round as described above. If no players remain at the table, the method concludes at step 534.

While a blackjack game has been used in the above example, the method is not limited to blackjack. For example, another popular card game employed in gaming which may include a side game with a high stakes progressive is baccarat. There are a number of variations of the basic game of baccarat, and the game is sometimes referred to in its various forms as Baccarat-Chemin-de-Fer, Baccarat a deux tableaux, Mini-Baccarat, and the like. The rules may vary slightly, and rules may vary from casino to casino, but the underlying game is the same. The underlying game is a competition between two hands of cards, usually referred to as the banker and the player. House-banked games such as those games played in Las Vegas-style casinos may have a dealer's hand, rather than a banker's hand. However, the terms “dealer” and “banker” are interchangeable terms for purposes of this disclosure. All players at the table can place wagers, but in higher stakes games one player participates in the game by receiving a hand of cards; otherwise, the dealer handles both hands. Initially, two cards are dealt to each of the designated player and the designated banker hands. Each initial or partial two-card hand is reviewed by the banker and the player. The results of the competition are determined by how close the point total (explained in detail later) is to a value of nine. Two card hands with a point total of 8 or 9 are naturals. Point totals are based on the added face value of the cards, with the values of the cards being Ace=1, 2=2, 3=3, 4=4, 5=5, 6=6, 7=7, 8=8, 9=9, 10=0, Jack=0, Queen=0, and King=0. Only the last digit of the sum of the point values of the cards is operative in the play of the game. For example, a total value of the cards (both with the original hand or partial hand) would be read as 10=0, 11=1, 12=2, 13=3, 14=4, 15=5, 16=6, 17=7, 18=8, 19−9, 20=0, etc. A player is usually given the option of playing (wagering on) either the player's hand or the banker's hand. This is accomplished by placing the wager in a designated space for a wager on the banker's hand or the player's hand. A commission is usually extracted from the winning bets on the banker's hand (e.g., 5% of the winning bet on the banker's hand), because the banker usually wins more often than the player. No commissions are paid to the house when the player bets on the player's hand. There may also be a separate wager placed on the occurrence that the banker's hand and the player's hand will tic. Depending on the odds provided by the house (usually from 8:1, 9:1 of 10:1), the house advantage is between 4.5% and 15%.

In accordance with one or more embodiments, “Diamond Millions Baccarat” provides a large progressive side bet for baccarat. Diamond Millions Baccarat is an optional or mandatory side wager (at operators' discretion) for the standard game of baccarat. The players(s) bet on the outcome of either Player and/or Banker to have a Diamond Millions Hand (Queen and Nine of Diamonds). The payout is determined by the posted pay table and is a Community Jackpot (All players participating will split the winnings).

As described above, each player's position has an optional progressive betting spot. To begin each round, players are required to place a standard baccarat wager and the Diamond Millions Progressive wager. The patron may not make the Diamond Millions wager without a standard baccarat wager. If a player makes a Tie bet, they can still participate in the progressive. The amount wagered on the Diamond Millions spot must be the fixed amount (e.g., $1, $5, $25) posted on the table and are subject to all payout limitations posted by the casino. The Diamond Millions payouts may be subject to table aggregate payout limits set by the casino. In this game, there are two progressive jackpots, Major and Minor. The Major jackpot is won when both the Player and Banker are dealt a Diamond Millions Baccarat Hand (Queen and Nine of Diamonds). The Minor jackpot is won if either Player or Banker has a Diamond Millions Hand and the other hand is a Suited Nine Zero, where “Nine Zero” is any nine valued card (9) and any ten (10) or face valued card (J, Q, K)

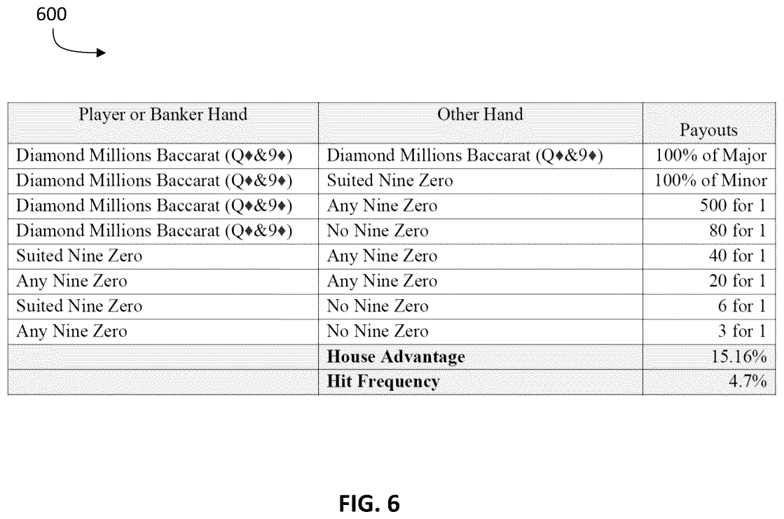

FIG. 6 provides an example of a Diamond Millions Baccarat bonus pay table 600. As a $5 bet, the average progressive value will be between $3- and $5 million, with an additional amount of about $90,000, roughly equivalent to the envy bonus in Diamond Millions Blackjack added, and with this award divided among all participating players at the table. The average number of hands between primary progressive wins is the same as Diamond Millions Blackjack: 2,581,860. This allows participating baccarat tables to be linked with participating blackjack tables to more easily achieve the desired 200 total tables preferred to drive sufficient growth of the progressive pools. Again, with an average of 500 hands per day across all participating blackjack and baccarat tables, the progressive should hit, on average, every 26 days.

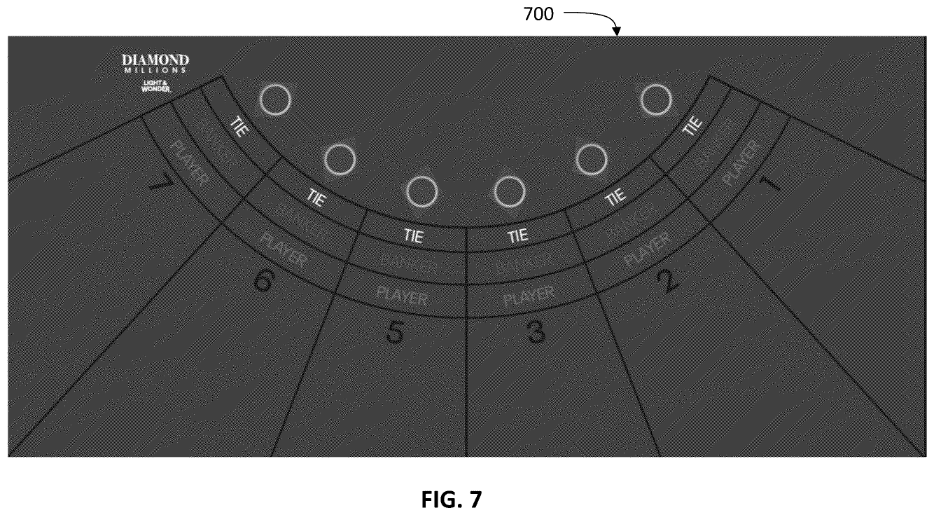

FIG. 7 illustrates an example of a gaming table layout 700 (akin to gaming table layout 110 of FIG. 1) that may be used with the exemplar Diamonds Millions Baccarat side game. In this game, each player position has a side wager spot with a token sensor 250, as described above. To participate in the progressive, a player makes his or her base bet and can then place a $5 bet on the corresponding token sensor. A secondary progressive is won when one hand has a Diamond Millions Baccarat, and the other has any other suited Nine Zero (a Nine Zero is a nine and any ten or face card). If the Diamond Millions hand is dealt, then all players at the table participating in the side game divide the jackpot. As in Diamond Millions Blackjack, the secondary progressive should average just over $100,000 when hit and should hit, on average, every 123,652 hands. With a combined 200 tables and 500 hands per day, the secondary progressive should, as described above, be won approximately every 1.24 days. The House Advantage in the example of FIG. 6 is at least 15%. The hit frequency is 4.7%.

Due to the nature of the triggering hands, this game is preferably dealt from a continuous shuffler and ideally will have the above-described guaranteed security that the triggering hands were actually dealt (FIG. 5B, step 524), that is, that no cards were substituted by a player, dealer or bystander.

In this description, numerous specific details are set forth. However, it is understood that embodiments of the invention may be practiced without these specific details. Although specific ranges, specific compositions, and specific components have been identified to enable preferred practice of the present technology, one skilled in the art, reading the specification and viewing the figures, understands the generic concepts disclosed herein. This understanding enables the use of alternatives and options and design changes within the skill of the ordinary artisan in the electronics and imaging field, without undue experimentation and within the scope of the claims.

For example, while the above exemplar games utilize six decks of playing cards, in some embodiments, four or more decks, for example, seven decks, may be used. In accordance with still other embodiments, fewer decks may be used. For example, when a continuous shuffler is used, as few two decks provide enough cards for at least one player at the gaming table to win the primary progressive award. Furthermore, the above-described games are also intended to be cross-platform and can be used with electronic tables, digital tables, and other devices including online gaming. In these scenarios, as few as two continuously shuffled decks may also be sufficient. These variations may require adjustment to the pay table, however such adjustments are well within the abilities of those skilled in the art of pay table design.

In other instances, well-known circuits, structures and techniques have not been shown in detail in order not to obscure the understanding of this description. Note that in this description, references to “one embodiment” or “an embodiment” mean that the feature being referred to is included in at least one embodiment of the invention. Further, separate references to “one embodiment” in this description do not necessarily refer to the same embodiment; however, neither are such embodiments mutually exclusive, unless so stated and except as will be readily apparent to those of ordinary skill in the art. Thus, the present invention can include any variety of combinations and/or integrations of the embodiments described herein. Each claim, as may be amended, constitutes an embodiment of the invention, incorporated by reference into the detailed description. Moreover, in this description, the phrase “exemplary embodiment” means that the embodiment being referred to serves as an example or illustration.

Block diagrams illustrate exemplary embodiments of the invention. Flow diagrams illustrate operations of the exemplary embodiments of the invention. The operations of the flow diagrams are described with reference to the example embodiments shown in the block diagrams. However, it should be understood that the operations of the flow diagrams could be performed by embodiments of the invention other than those discussed with reference to the block diagrams, and embodiments discussed with references to the block diagrams could perform operations different than those discussed with reference to the flow diagrams. Additionally, some embodiments may not perform all the operations shown in a flow diagram. Moreover, it should be understood that although the flow diagrams depict serial operations, certain embodiments could perform certain of those operations in parallel or in a different sequence.

Each of these embodiments and obvious variations thereof is contemplated as falling within the spirit and scope of the claimed invention, which is set forth in the following claims. Moreover, the present concepts expressly include any and all combinations and subcombinations of the preceding elements and aspects.

What is claimed is:

1. A gaming table progressive system comprising:
a plurality of gaming tables, each of the plurality of gaming tables comprising a card handling device, one or more displays, and a plurality of sensors for detection of progressive game wagers;
and a progressive game manager communicatively coupled to the plurality of sensors, the card handling device, and the one or more displays;
wherein the plurality of sensors, the card handling device, the one or more displays and the progressive game manager collectively include logic-circuitry configured to:
accept at least one progressive wager on a progressive side game in response to a signal from the plurality of sensors;
signal the acceptance of the at least one progressive wager to the progressive game manager;
increment, by the progressive game manager, at least one progressive pool in response to the at least one accepted progressive wager;
identify, by the card handling device, a plurality of first cards distributed from the card handling device;
present a first anticipation event based on the identified first cards;
identify, by the card-handling device, a plurality of second cards distributed from the card handling device;
present a second anticipation event based on the identified second cards;
detect a progressive win event based on the identified first cards and the identified second cards;
display confirmation of the progressive win event on the one or more displays; and
award, by the progressive game manager, a prize according to the incremented progressive pool.

2. The system of claim 1, wherein the one or more displays comprise a table sign.

3. The system of claim 2 wherein presenting the first or second anticipation event comprises displaying the first or second anticipation event on the table sign.

4. The system of claim 3, wherein the table sign comprises one or more emotive lighting strips and wherein presenting the first or second anticipation event comprises displaying the first or second anticipation event on the one or more emotive lighting strips.

5. The system of claim 1, wherein the one or more displays comprise a display integrated into each of the plurality of sensors.

6. The system of claim 5, wherein presenting the first or second anticipation event comprises displaying the first or second anticipation event on at least one of the displays integrated into the plurality of sensors.

7. The system of claim 1, wherein presenting the first or second anticipation event comprises an audio component.

8. The system of claim 1, wherein the logic-circuitry further comprises a vision system for correlating active positions at the gaming table with the at least one accepted progressive wager.

9. The system of claim 1, wherein the logic-circuitry further includes a plurality of sensors for detection of base game wagers for correlating active positions at the gaming table with the at least one accepted progressive wager.

10. The system of claim 1, wherein the card handling device comprises a continuous shuffler.

11. A method of operating a gaming table progressive system comprising a plurality of gaming tables, each of the plurality of gaming tables including a plurality of sensors for detection of progressive game wagers, a card handling device and one or more displays; and
a progressive game manager communicatively coupled to the plurality of sensors, to the card handling device, and to the one or more displays;
wherein the plurality of sensors, the card handling device, the one or more displays and the progressive game manager collectively include logic-circuitry configured to perform the method, comprising:
for each of the plurality of gaming tables:
accepting at least one progressive wager on a progressive side game in response to a signal from the plurality of sensors and signaling the acceptance to the progressive game manager;
incrementing, by the progressive game manager, at least one progressive pool in response to the at least one accepted progressive wager;
identifying a plurality of first cards distributed from the card handling device;
presenting a first anticipation event based on the identified first cards;
identifying a plurality of second cards distributed from the card handling device;
presenting a second anticipation event based on the identified second cards;
detecting a progressive win event based on the identified first cards and the identified second cards;
displaying confirmation of the progressive win event on the one or more displays; and
awarding a prize according to the incremented progressive pool.

12. The method of claim 11, wherein the one or more displays comprises a table sign.

13. The method of claim 12 wherein presenting the first or second anticipation event comprises displaying the first or second anticipation event on the table sign.

14. The method of claim 13, wherein the table sign comprises one or more emotive lighting strips and wherein presenting the first or second anticipation event comprises displaying the first or second anticipation event on the one or more emotive lighting strips.

15. The method of claim 11, wherein the one or more displays comprise a display integrated into each of the plurality of sensors.

16. The method of claim 15, wherein presenting the first or second anticipation event comprises displaying the first or second anticipation event on at least one of the displays integrated into the plurality of sensors.

17. The method of claim 11, wherein presenting the first or second anticipation event comprises an audio component.

18. The method of claim 11, wherein the logic-circuitry further comprises a vision system for correlating active positions at the gaming table with the at least one accepted progressive wager.

19. The method of claim 11, wherein the logic-circuitry further includes a plurality of sensors for detection of base game wagers for correlating active positions at the gaming table with the at least one accepted progressive wager.

20. The method of claim 11, wherein the card handling device comprises a continuous shuffler.
